(19) United States
(12) Patent Application Publication
(10) Pub. No.: US 2013/0144728 A1
(43) Pub. Date: Jun. 6, 2013

(54) PRE-PROCESSING OF AD REQUESTS USING EDGE SIDE PROCESSING OVER COMMERCIAL CDNs

(71) Applicants: Fernando Ruarte, San Fransico, CA (US); Samir Arora, Woodside, CA (US); Arthur Schram, Davis, CA (US); Mayur Bhatia, Oakland, CA (US); Darshana Munde, Pune (IN); Ashok Srinivas, Pune (IN)

(72) Inventors: Fernando Ruarte, San Fransico, CA (US); Samir Arora, Woodside, CA (US); Arthur Schram, Davis, CA (US); Mayur Bhatia, Oakland, CA (US); Darshana Munde, Pune (IN); Ashok Srinivas, Pune (IN)

(21) Appl. No.: 13/489,716

(22) Filed: Jun. 6, 2012

Related U.S. Application Data
(60) Provisional application No. 61/494,117, filed on Jun. 7, 2011.

(51) Int. Cl. G06Q 30/02

(52) U.S. Cl. CPC G06Q 30/0277
USPC 705/14.73

(57) ABSTRACT

By distributing the algorithms for ad selection into two server tiers, an ad server platform provides a way to leverage the computing power of a commercial CDN, such as Akamai, and perform processing on the CDN's edge side servers, thus reducing the number of servers in its own data centers and increasing service availability. The ad serving platform implements a distributed processing methodology that leverages under-utilized server resources located on the edge side of the CDN by running edge side include (ESI) code on the CDN's edge servers.

### PRIORITY CLAIM

This application claims the benefit of U.S. Provisional Application No. 61/494,117, filed on Jun. 7, 2011, by Ruarte et al. and titled “Pre-Processing of Ad Requests Using Edge Side Processing Over Commercial CDNs.” Provisional Application No. 61/494,117 is hereby incorporated by reference herein in its entirety.

### FIELD OF THE INVENTION

The present invention relates to online display advertising and, in particular, to ad serving systems and methods that implement a distributed methodology that leverages under-utilized servers located on the edge side of a commercial content delivery network (CDN) by running custom edge side include (ESI) code on the CDN's edge servers.

### BACKGROUND OF THE INVENTION

The algorithm behind the display of an advertisement on a web site is a complex client server computing mechanism that requires a client computer to issue requests to an ad serving platform to select an ad and generate the code required to display the ad. This operation requires that calls to the ad serving platform respond with sub-second latencies, usually below 500 ms per request.

The operation of a large ad serving network requires large amounts of computing power. Increasingly complex ad targeting and ad matching algorithms call for more powerful data centers that can handle an increasing number of ad selections per second within a decreasing expected latency.

As described in greater detail below, the present invention innovates in this field and obtains massive scalability at a very low cost by distributing the processing required to select an ad into three tiers:

1. A client computer tier being used by the end user;

2. Server Tier I: the edge side processing power of a commercial CDN (Content Delivery Network); and

3. Server Tier II: the ad server platform processing, located in regionally distributed data centers.

See http://en.wikipedia.org/wiki/Content_delivery_network (which is hereby incorporated by reference herein in its entirety) for a description of the capabilities of a CDN.

### SUMMARY

By distributing the algorithms for ad selection into two server tiers, an ad server platform in accordance with the concepts of the present invention provides a way to leverage the computing power of a commercial CDN, such as Akamai, and perform processing on the CDN's edge side servers, thus reducing the number of servers in its own data centers and increasing service availability. The ad serving platform implements a distributed processing methodology that leverages under-utilized server resources located on the edge side of the CDN by running edge side include (ESI) code on the CDN's edge servers.

The features and advantages of the various aspects of the subject matter disclosed herein will be more fully understood and appreciated upon consideration of the following detailed description and accompanying drawings, which set forth illustrative embodiments in which the concepts of the claimed subject matter are utilized.

### BRIEF DESCRIPTION OF THE DRAWINGS

FIG. 1 is a block diagram illustrating the architecture of an ad server platform in accordance with the concepts of the present invention, from client computer to data caching servers.

FIG. 2 is a block diagram illustrating the architecture of an ad serving platform with regional dispatch being performed at the DNS level.

FIG. 3 is a block diagram illustrating the architecture of an ad server platform in accordance with the concepts of the present invention with regional dispatch and server Tier I logic being processed on the edge of a CDN.

### DETAILED DESCRIPTION

The following is extracted from http://en.wikipedia.org/wiki/Content_delivery_network and describes a CDN, its model and usage:

“CDN Benefits

The capacity sum of strategically placed servers can be higher than the network backbone capacity. This can result in an impressive increase in the number of concurrent users. For instance, when there is a 10 Gbit/s network backbone and 200 Gbit/s central server capacity, only 10 Gbit/s can be delivered. But when 10 servers are moved to 10 edge locations, total capacity can be 10×10 Gbit/s.

Strategically placed edge servers decrease the load on interconnects, public peers, private peers and backbones, freeing up capacity and lowering delivery costs. It uses the same principle as above. Instead of loading all traffic on a backbone or peer link, a CDN can offload these by redirecting traffic to edge servers.

CDNs generally deliver content over TCP and UDP connections. TCP throughput over a network is impacted by both latency and packet loss. In order to reduce both of these parameters, CDNs traditionally place servers as close to the edge networks that users are on as possible.

Theoretically, the closer the content, the faster the delivery, although network distance may not be the factor that leads to best performance. End users will likely experience less jitter, fewer network peaks and surges, and improved stream quality—especially in remote areas. The increased reliability allows a CDN operator to deliver HD quality content with high quality of service, low costs and low network load.

CDNs can dynamically distribute assets to strategically placed redundant core, fallback and edge servers. CDNs can have automatic server availability sensing with instant user redirection. A CDN can offer 100% availability, even with large power, network or hardware outages. CDN technologies give more control of asset delivery and network load. They can optimize capacity per customer, provide views of real-time load and statistics, reveal which assets are popular, show active regions and report exact viewing details to the customers. These usage details are an important feature that a CDN provider must provide, since the usage logs are no longer available at the content source server after it has been plugged into the CDN, because the connections of end-users are now served by the CDN edges instead of the content source.”

As described above, a CDN (such as, for example, Akamai) is usually used by its customers to increase content availability, increase speed of delivery and reduce network load by caching objects at the “edge” of the network using a highly geographically distributed network of servers and storage equipment that keeps copies of their customer's content closer to the end users. This method focuses 100% of the usage of the CDN's infrastructure on the amount of storage and bandwidth utilized by the customer's cached content that is hosted by the CDN on their behalf. As a matter of fact, all of the CDN's pricing models have two components: the number of Gigabytes hosted and the number of Gigabytes served by the CDN's own internet network access. No CDN prices its service based on the CPU power used on their edge servers because their customers buy storage and network capacity, not CPU processing capacity.

Embodiments of the disclosed ad serving platform leverage the CPU power of a CDN's edge servers by not only caching the programs, but also executing them on the same distributed data centers that host them on the edge of the internet. This approach leverages the ability of a CDN's edge server to execute programming languages such as Java or ESI.

Architecture Description

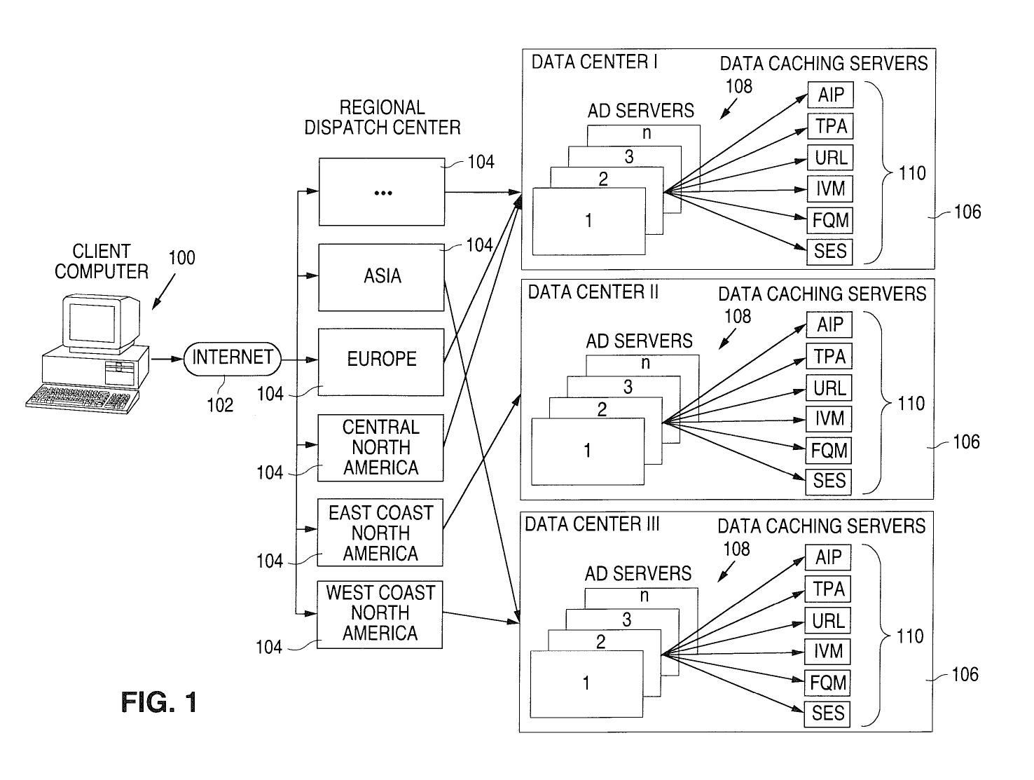

As shown in the FIG. 1 architecture diagram, each request from a client computer 100 via the Internet 102 is processed via a regional dispatch center 104 and directed to a given data center 106. Each data center 106 contains ad servers 108, which process the ad selection logic, and data caching servers (DCS) 110, which manage volatile information using fast, transactional in memory storage software such as, for example, memcache.

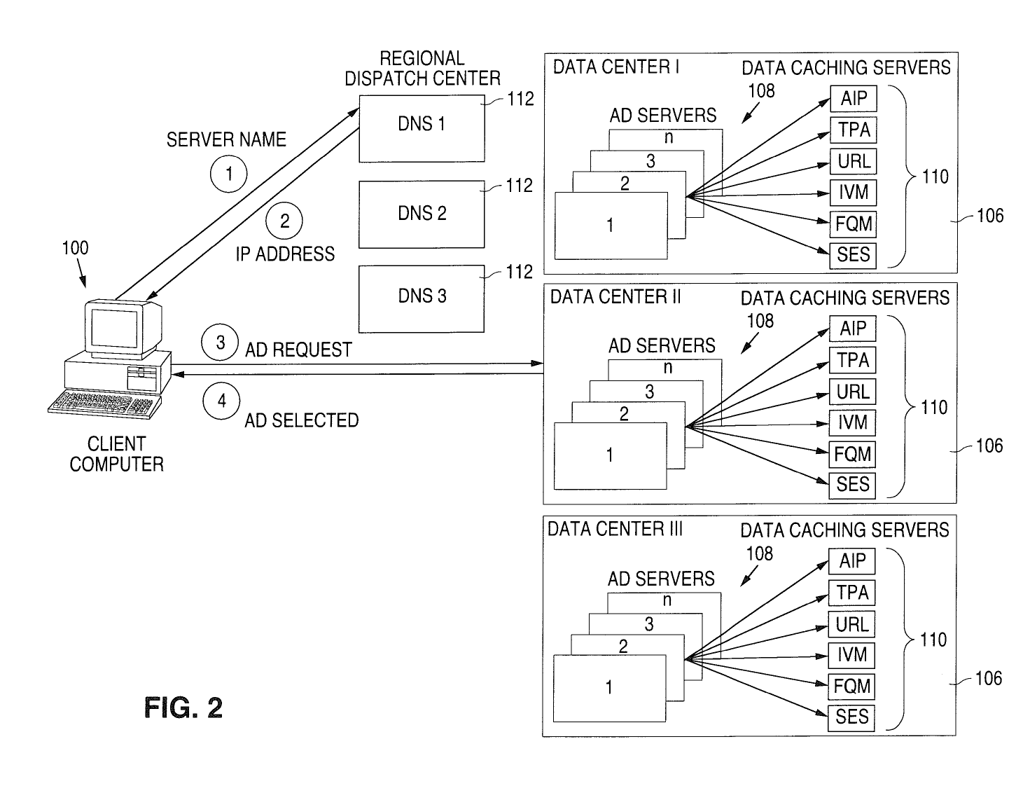

Referring to FIG. 2, in a traditional model, the layer of processing performed by the illustrated “Regional Dispatch Center” is the DNS (see http://en.wikipedia.org/wiki/Domain_Name_System) infrastructure provider. (See also http://sanjuan2007.icann.org/files/sanj uan/NeustarUltraServices-CriticalDNSInfrastructureforTLDOperators.pdf for an example of a DNS provider network). In this model, the provider of DNS services 112 maps the IP address for a requested server name to the closest (or fastest) desired data center 106. Acting as a regional dispatch center 104, all the computers from the DNS provider 112 do for the customer is mapping of a server name to an IP address based upon on predefined rules established by the customer. No real backend processing offload is performed by a DNS provider 112.

In the FIG. 2 model, a client computer 100 that needs to issue a request for an ad, first queries a DNS server 112 to get the IP address for the servers or data center to point to. The DNS infrastructure provider resolves the server name to the IP address of the closest regional data center 106 and returns it to the client computer 100. The client computer 100 makes a call to a selected data center 106 to request an ad selection. The ad servers 108 from the selected data center 106 return the selected ad to the client computer 100.

Using the FIG. 2 traditional model presents three drawbacks. Implementing a high availability solution requires additional processing logic on the client computer 100 as well as on the data center 106. 100% of the processing for each ad selection is performed by the servers 108 inside the data center 106, requiring large “islands” of servers together to keep up with the load. The client computer 100 communicates with the data center 106 directly via the Internet, centralizing traffic from all client computers 100 coming from specific regions, thus forcing each data center 106 to process a large number of slow connections. A large number of slow connections connecting to a data center 106 creates the need for bigger, higher performance and, therefore, more expensive networking infrastructure

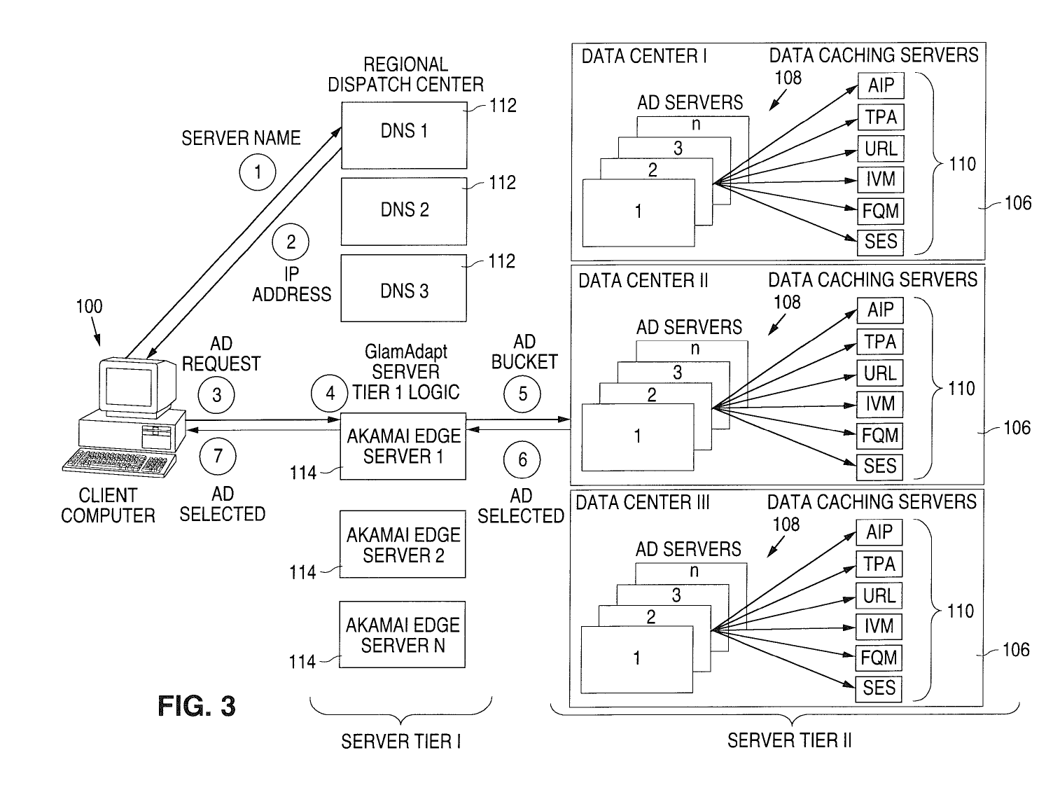

In the ad server platform model shown in FIG. 3, the regional dispatch center lies within the edge side network of a CDN such as, for example, Akamai. The Akamai network has over 84,000 servers in over 1000 networks across over 70 countries (See http://wwvv.akamai.comihtml/technology/edgeplatform.html). Compared to the fourteen data centers over five countries available to the NeuStar UltraDNS Services (one of the biggest DNS providers in the world), it is clear that a CDN such as Akamai brings many orders of magnitude more processing power and can therefore provide a service of deeper value to its customers.

Because the FIG. 3 Server Tier I logic is written using the ESI programming language, each server within the Akamai network is capable of processing the ad serving platform's code. This model effectively ads the computing power of 84,000 servers to the ad serving platform's data centers processing power. Because of its distributed architecture that uses Akamai's CDN edge servers to pre-process the ad calls at its Regional Dispatch Center tier, the FIG. 3 ad serving platform can serve thousands of ad selection requests per second in a configuration that utilizes three data centers worldwide with less than three hundred servers.

The FIG. 3 data flow is as follows. A client computer 100 that needs to issue a request for an ad, first queries a DNS server 112 to obtain the IP address for the servers or data center to point to. The DNS infrastructure provider 112 resolves the server name to the IP address of the closest Akamai CDN edge server 114 and returns the IP address to the client computer 100. The client computer 100 makes an ad call to the Akamai CDN edge server 114 to request an ad selection. An edge server 114 within the Akamai CDN network receives the request and executes the ad serving platform's Server Tier I logic. This logic is written in ESI language and performs the evaluation of hundreds of ad targeting rules that include the filtering of the ads available for different geographic zones. Once the Server Tier I logic has concluded the “bucket” of ads from which to select, the edge server 114 makes an ad call to one of the ad serving platform's data centers 106, sending the “bucket id” of ads from which to select. If that request fails or takes longer than a defined time period, e.g., 500 ms, the Edge Server Tier I logic aborts the request and tries the same call on a different data center 106, thus providing high availability and failover processing rules. If the second call to a different data center 106 fails or takes longer than the defined time period, then the Server Tier I logic executes a “default ad selection logic” algorithm that is programmed to still show an ad following a simple selection from among a few default targeting criteria. The data center 106 responds with a selected final ad. The final ad selected is passed back to the client computer 100 by the Akamai CDN edge server 114.

In the FIG. 3 model, failover and high availability are provided by the logic running on the edge servers 114 that acts as a proxy and, therefore, does not require any custom code on the client computer 100 or the data centers 106. Because the edge servers 114 from the CDN are performing the Server Tier I processing and determining the “ads bucket” to be sent as the ad selection input to the data center 106, the processing is distributed between the edge server 114 and the data center 106, thus requiring significantly fewer ad servers 108. Because the client computer 100 lives on a slower edge tier of the Internet and only communicates with the edge server 114 on the CDN, the communication to the data centers 106 happens from edge servers 114 on a peer to peer network. This assures minimum latency for the client computer 100 and reduced network infrastructure requirements on each data center 106.

It should be understood that the particular embodiments of the invention described herein have been provided by way of example and that other modifications may occur to those skilled in the art without departing from the scope of the claimed subject matter as expressed in the appended claims and their equivalents.

What is claimed is:

1. A computer implemented method of pre-processing ad requests utilizing an ad serving platform, the method comprising:
utilizing a DNS server to receive a query from a client computer that needs to issue a request for an ad, the DNS server providing the IP address for an ad server, the DNS server resolving the ad server name to a CDN edge server and returning the IP address to the client computer;
utilizing the CDN edge server to receive an ad call from the client computer, the ad call requesting an ad selection, whereby an edge server within a CDN network receives the ad call and executes Edge Server Tier I logic to determine a bucket of ads from which to select;
after the Edge Server Tier I logic has determined the bucket of ads from which to select, utilizing the CDN edge server to make an ad call to one of a plurality of data centers, the ad call sending the bucket id of ads from which to select;
utilizing the data center to respond with a selected final ad; and
utilizing the CDN edge server to provide the selected final ad to the client computer.

2. The method of claim 1, wherein the Edge Server Tier I logic is written in the ESI programming language.

3. The method of claim 1, wherein the CDN edge server comprises an Akamai edge server.

4. The method if claim 1, wherein
if the ad call to the data center fails or takes longer than a defined time period, utilizing the Edge Server Tier I logic to abort the ad call and make the same ad call on a second of the plurality of data centers; and
if the ad call made on the second data center fails or takes longer than the defined time period, utilizing the Edge Server Tier I logic to execute a default ad selection algorithm that is programmed to select an ad following one or more default targeting criteria.

5. The method of claim 4, wherein the defined time period is about 500 ms.

6. An ad serving platform for pre-processing ad requests, the ad serving platform comprising:
a DNS server that receives a query from a client computer that needs to issue a request for an ad, the DNS server providing the IP address for an ad server, the DNS server resolving the ad server name to a CDN edge server and returning the IP address to the client computer;
a CDN edge server that receives an ad call from the client computer, the ad call requesting an ad selection, whereby an edge server within a CDN network receives the ad call and executes Edge Server Tier I logic to determine a bucket of ads from which to select and, after the Edge Server Tier I logic has determined the bucket of ads from which to select, the CDN edge server makes an ad call to one of a plurality of data centers, the ad call sending the bucket id of ads from which to select, the data center responding with a final selected ad, the CDN edge server providing the final selected ad to the client computer.

7. The ad serving platform of claim 6, wherein the Edge Server Tier I logic is written in the ESI programming language.

8. The ad serving platform of claim 6, wherein the CDN edge server comprises an Akamai edge server.

9. The ad serving platform of claim 6, wherein
if the ad call to the data center fails or takes longer than a defined time period, the Edge Server Tier I logic aborts the ad call and makes the same ad call on a second of the plurality of data centers; and
if the ad call made on the second data center fails or takes longer than the defined time period, the Edge Server Tier I logic executes a default ad selection algorithm that is programmed to select an ad following one or more default targeting criteria.

10. The ad serving platform of claim 6, wherein the defined time period is about 500 ms.
